(19) United States
(12) Patent Application Publication
(10) Pub. No.: US 2011/0053606 A1
(43) Pub. Date: Mar. 3, 2011

(54) METHOD AND DEVICE FOR NOTIFYING A LOCATION SERVICES CLIENT THAT A TARGET TERMINAL IS UNREACHABLE

(75) Inventors: Xiao-Ming Yao, Beijing (CN); Li-Jun Chang, Beijing (CN); Lai-Jun Zhang, Beijing (CN)

(73) Assignee: MOTOROLA, INC., Schaumburg, IL (US)

(21) Appl. No.: 12/551,660

(22) Filed: Sep. 1, 2009

(51) Int. Cl. H04W 4/02

(52) U.S. Cl. 455/456.1

(57) ABSTRACT

A method and device enables notifying a location services client that a target terminal is unreachable. The method (400) includes receiving at a location server from the location services client a location reporting request message that requests information about the location of the target terminal (step 405). A positioning session is then established between the location server and the target terminal (step 410). It is then determined at the location server that a location report from the target terminal is overdue (step 420) and that the target terminal is unreachable (step 425). Finally, a notification message is transmitted from the location server to the location services client indicating that the target terminal is unreachable (step 430).

### FIELD OF THE DISCLOSURE

The present invention relates generally to location services for portable electronic devices, and in particular to notifying a location services client that a target terminal is unreachable.

### BACKGROUND

Mobile telephones and other portable electronic devices increasingly include a locating feature that enables a current geographic location of the devices to be either displayed on the devices or transmitted to a remote receiver. These features are generally called location services (abbreviated as LCS, for “LoCation Services”). LCS features that display location coordinates on a device are useful, for example, to device users who need to know where they are located relative to geographic map coordinates. Thus, LCS features can enable a device user to initiate a location request where the device acts as a Global Positioning System (GPS) terminal. Also, location requests may be initiated by third parties and transmitted to a device over a wireless network. Such third party requests are useful in various circumstances. For example, mobile telephone networks may be able to improve network efficiency and provide better Quality of Service (QoS) and roaming rates to a mobile user if the network can periodically monitor a mobile telephone location. Also, emergency services can sometimes save lives by rapidly and accurately identifying where emergency phone calls have originated. Other useful location-based services and data that can be provided through portable electronic devices include maps, weather forecasts, traffic data and local news.

Various locating technologies can be used to determine the location of a portable electronic device. For example, the Global Positioning System (GPS) can be used to identify a location anywhere in the world of some mobile telephones. Further, because mobile telephones are already operatively connected to land-based network stations, the stations can transmit GPS satellite orbit parameters and navigation data to mobile telephones to aid fast acquisition of GPS satellites when a mobile telephone first starts its GPS function. Thus Assisted GPS (A-GPS) services are commonly used to incorporate better and more efficient location services into mobile telephones. Secure User Plane Location (SUPL) is a technology developed by the Open Mobile Alliance (OMA) that concerns the transfer of assistance data and positioning data between a portable electronic device and a location platform, and includes standards such as the Open Mobile Alliance Secure User Plane Location 2.0 Periodic Trigger standard. A “user plane” means that assistance data and positioning data are transmitted between the device and the location platform over a conventional wireless communication channel such as a General Packet Radio Service (GPRS) channel. User plane communications are thus distinguished from control plane communications where assistance data and positioning data are transmitted between a device and a location platform over a packet switched (PS) channel in a network.

Other SUPL applications include monitoring the location of one or more mobile devices from a remote location. For example, a dispatch center of a delivery company or a command station of an emergency response team may need to monitor the location of individuals or vehicles in the field. In such applications the dispatch center or command station is referred to as an LCS client and monitored electronic devices are referred to as target SUPL Enabled Terminals (SETs). The LCS client receives location data concerning a SET indirectly through a SUPL location server.

However, after an LCS session is established between an LCS client and a SUPL location server concerning a particular target SET, if the target SET is subsequently powered off or otherwise becomes out of service, the SUPL location server may continue to report the most recently updated location information of the target SET to the LCS client, which information may be inaccurate. That can result in inaccurate location information being used by the LCS client, and waste processing and power resources of both the LCS client and the SUPL location server.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram illustrating a wireless communication network that provides location services, according to an embodiment of the present invention.

FIG. 2 is a message sequence chart illustrating a method for notifying an LCS client that a target SET is unreachable, according to an embodiment of the present invention.

FIG. 3 is a message sequence chart illustrating a method for notifying an LCS client that a target SET is unreachable, according to another embodiment of the present invention.

FIG. 4 is a flow diagram illustrating a method for notifying a location services client that a target terminal is unreachable, according to an embodiment of the present invention.

FIG. 5 is a block diagram illustrating components of a location server, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, a method enables notifying a location services client that a target terminal is unreachable. The method includes receiving at a location server from the location services client a location reporting request message that requests information about the location of the target terminal. A positioning session is then established between the location server and the target terminal. Next, it is determined at the location server that a location report from the target terminal is overdue and that the target terminal is unreachable. Finally, a notification message is transmitted from the location server to the location services client indicating that the target terminal is unreachable.

Embodiments of the present invention thus enable an LCS client to be promptly notified when a location server may be unable to accurately report a position of a target terminal because, for example, the target terminal has become out of service or has been powered off. The LCS client is then able to terminate the positioning session with the location server and employ alternative locating methodologies. The LCS client is thus less likely to use inaccurate or outdated positioning data, and processor and power resources of the LCS client, the location server, and the network in which they operate, can be conserved.

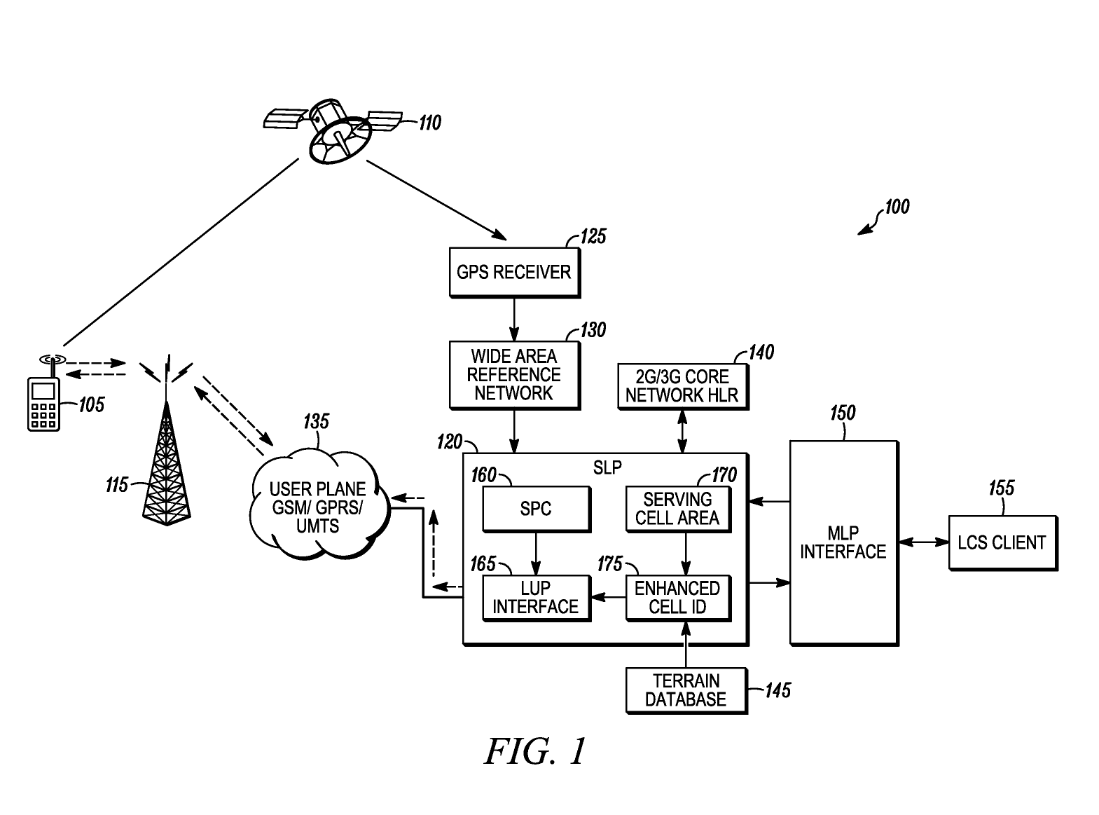

Referring to FIG. 1, a schematic diagram illustrates a wireless communication network 100 that provides location services, according to an embodiment of the present invention. A target SET 105 in the form of a mobile telephone is in radio frequency (RF) communication with a satellite 110 and a cell tower 115. The satellite 110 is in communication with a location server 120 in the form of a SUPL location platform (SLP) through a GPS receiver 125 and a wide area reference network 130. The cell tower 115 is also in communication with the location server 120 through a user plane 135. The location server 120 is further operatively connected to a home location register (HLR) 140 of the target SET 105, a terrain database 145, and a mobile location protocol (MLP) interface 150 that interfaces with an LCS client 155. As will be understood by those having ordinary skill in the art, the LCS client 155 can be any device or system that requests the services of the location server 120, such as another mobile telephone, computer, or computer server.

The wide area reference network 130 is operatively coupled to a SUPL positioning center 160, which interacts with a LUP interface 165. The LUP interface 165 is used to deliver messages to and from the SET 105 for SUPL service management and SUPL positioning determination.

A serving cell area processing block 170 processes information concerning a serving cell area in which the target SET 105 operates. Further, an enhanced cell identification (ID) processing block 175 estimates the position of the target SET 105 based on an identification of the serving cell area in which the target SET 105 operates.

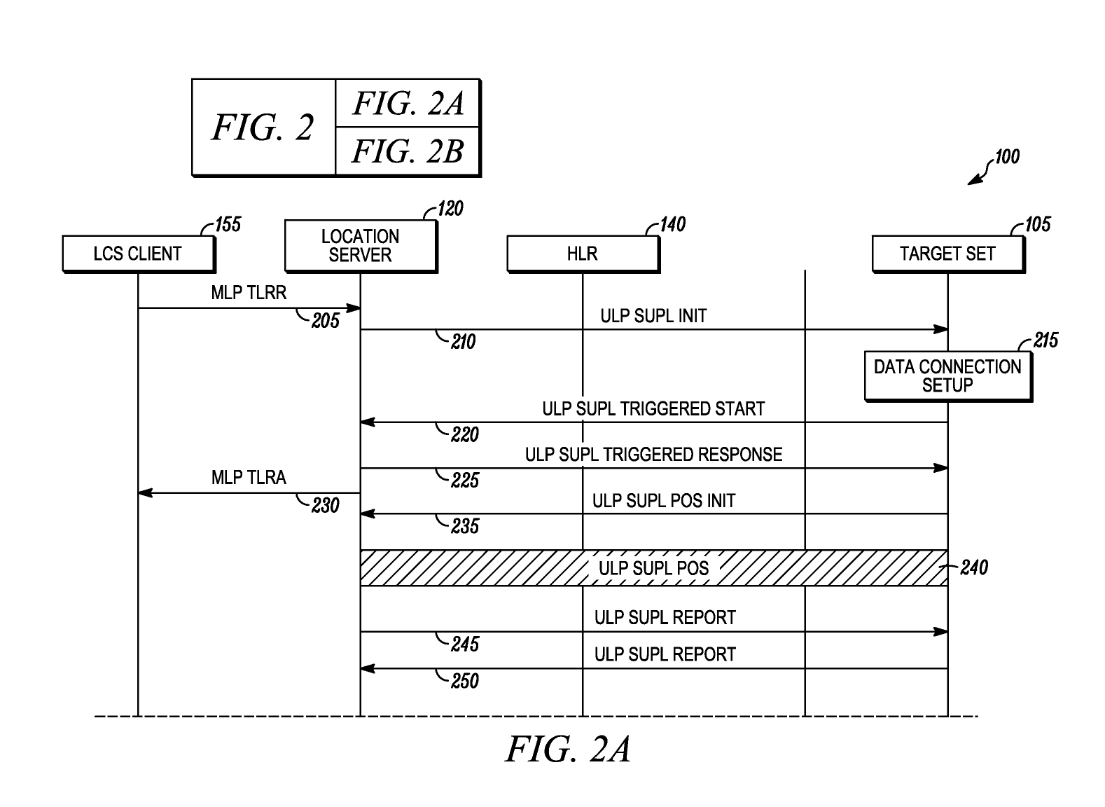

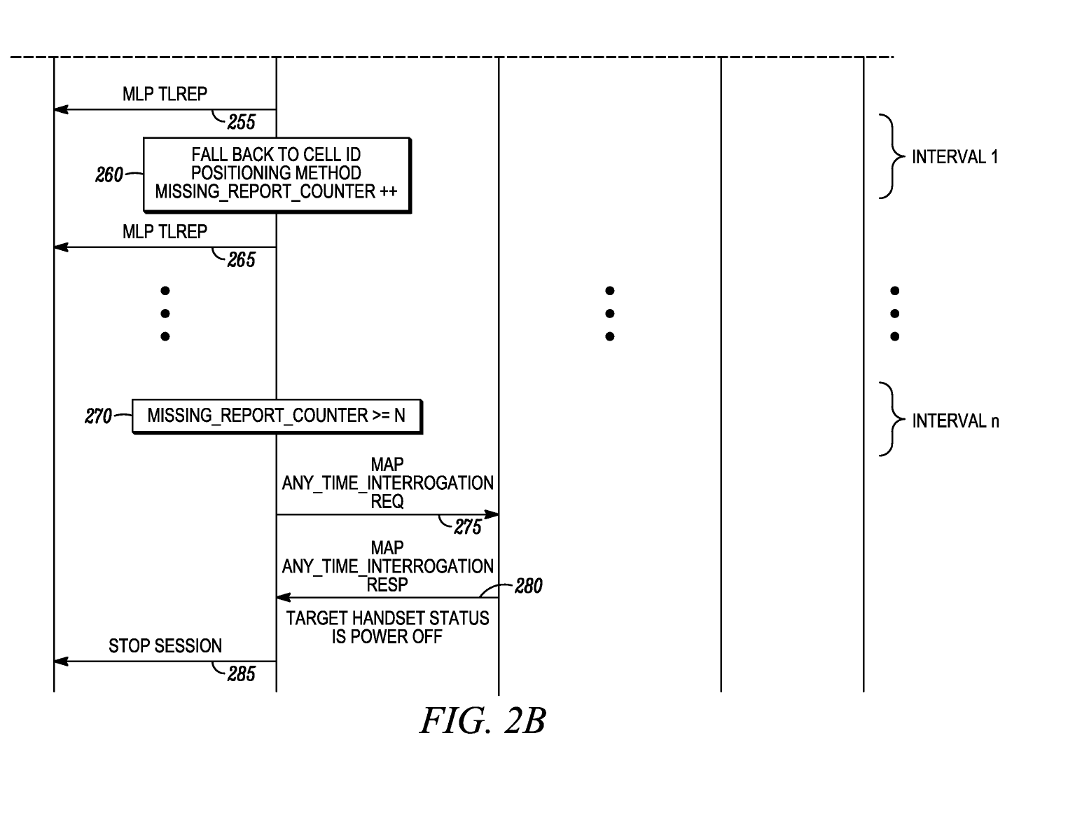

Referring to FIG. 2, a message sequence chart illustrates a method for notifying the LCS client 155, in the wireless communication network 100, that the target SET 105 is unreachable, according to an embodiment of the present invention. First, a mobile location platform trigger location reporting request (MLP TLRR) message 205 is transmitted from the LCS client 155 to the location server 120, and requests information about the location of the target SET 105. The location server 120 then transmits a user plane location protocol (ULP) SUPL initiation message 210 to the target SET 105, which message 210 initiates a network initiated SUPL positioning process. A data connection setup process 215 is then performed at the target SET 105, and the target SET 105 transmits a ULP SUPL triggered start message 220 back to the location server 120 to negotiate parameters of the positioning process with the location server 120. The location server 120 then transmits to the target SET 105 a ULP SUPL triggered response message 225, which is used to negotiate further parameters of the positioning process. The location server 120 also transmits to the LCS client 155 a MLP triggered location reporting answer (TLRA) message 230, which is an MLP protocol message that informs the LCS client 155 of the result of the MLP TLRR message 205.

The target SET 105 then responds to the location server 120 with a ULP SUPL position initiation message 235, which is a further ULP protocol message. A ULP SUPL positioning process 240, which is initiated by the location server 120, is then performed between the location server 120 and the target SET 105. The location server 120 then transmits to the target SET 105 a ULP SUPL report message 245, which requests a location report from the target SET 105. The target SET 105 then responds with another ULP SUPL report message 250, which delivers a GPS position result to the location server 120. The GPS position result is then transmitted from the location server 120 to the LCS client 155 in the form of a MLP trigger location report (TLREP) message 255.

Subsequently, the location server 120 expects to receive periodic additional ULP SUPL report messages from the target SET 105 and to transmit periodic additional MLP TLREP messages to the LCS client 155. However, if a particular “interval 1” of time expires after the location server 120 received the last ULP SUPL report message 250, then at block 260 the location server 120 determines that a ULP SUPL report message is overdue and changes to a backup positioning method such as a cell identification positioning method. As known by those having ordinary skill in the art, such a backup positioning method is generally significantly less accurate than a preferred positioning method such as AGPS. The location server 120 then transmits another MLP TLREP message 265, including positioning data obtained from the backup positioning method, to the LCS client 155.

According to one embodiment of the present invention, after the “interval 1” expires a missing report counter is incremented by one. Then, after each additional period of time equivalent to the period of “interval 1” expires, the missing report counter is further incremented by one. Finally, at block 270 the missing report counter reaches a predetermined value of “N”, such as a value between three and five set based on network congestion conditions, and it is determined at the location server 120 that the target SET 105 is unreachable. Therefore, a mobile application part (MAP) any_time_interrogation request message 275 is transmitted from the location server 120 to the HLR 140 over an Lh interface, which message 275 requests a status of the target SET 105. The HLR 140 then informs the location server 120 of a current status of the target SET 105. For example, the HLR 140 transmits a MAP any_time_interrogation response message 280 to the location server 120 that indicates that the target SET 105 is powered off. Alternatively, the HLR 140 may transmit a message to the location server 120 indicating that the target SET 105 is out of service. The location server 120 then transmits a stop session message 285 to the LCS client 155.

It will be understood by those having ordinary skill in the art the above example concerns networks such as global system for mobile (GSM) communication networks, wideband code division multiple access (WCDMA) networks, and time division synchronous-code division multiple access (TDS-CDMA) networks. Similar methods can be applied to other mobile communication networks such as CDMA2000 and worldwide interoperability for microwave access (WiMax) networks.

When the LCS client 155 receives the stop session message 285, the LCS client 155 can recognize that it is unable to obtain accurate positioning data concerning the target SET 105. The LCS client 155 is thus less likely to use inaccurate or outdated positioning data and, by terminating the positioning session with the location server 120, processor and power resources of the LCS client 155, the location server 120, and the wireless communication network 100 can be conserved.

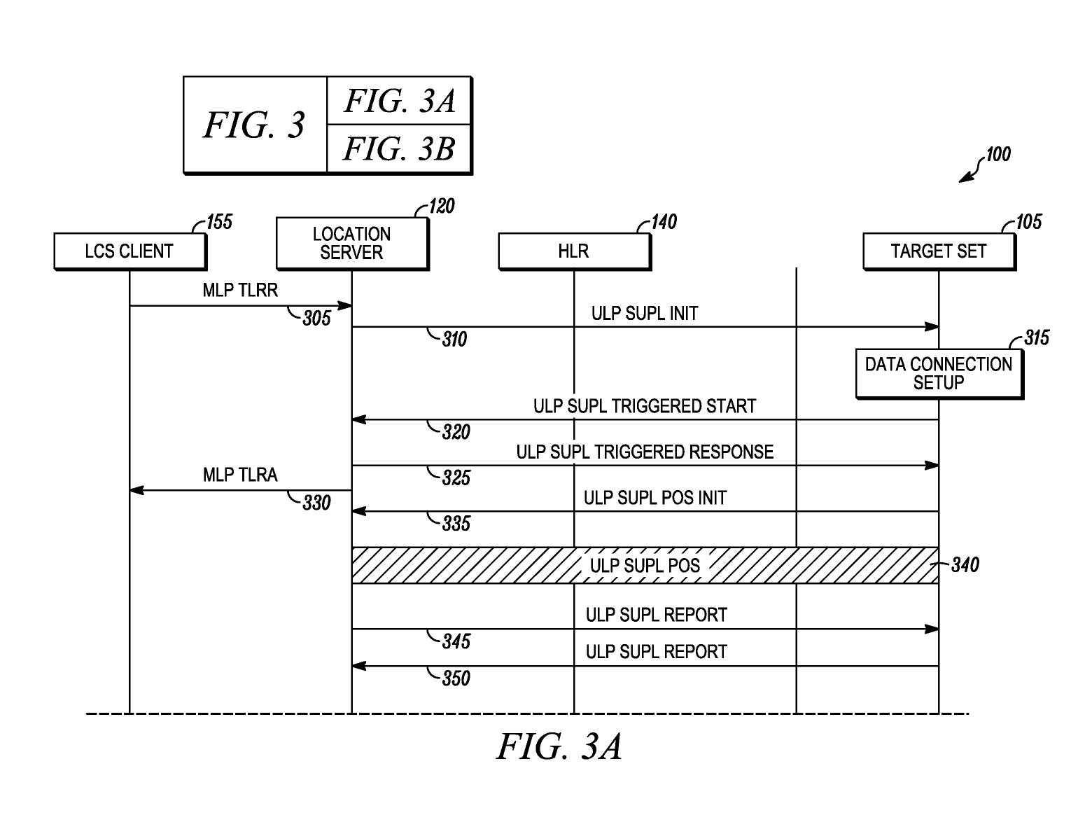

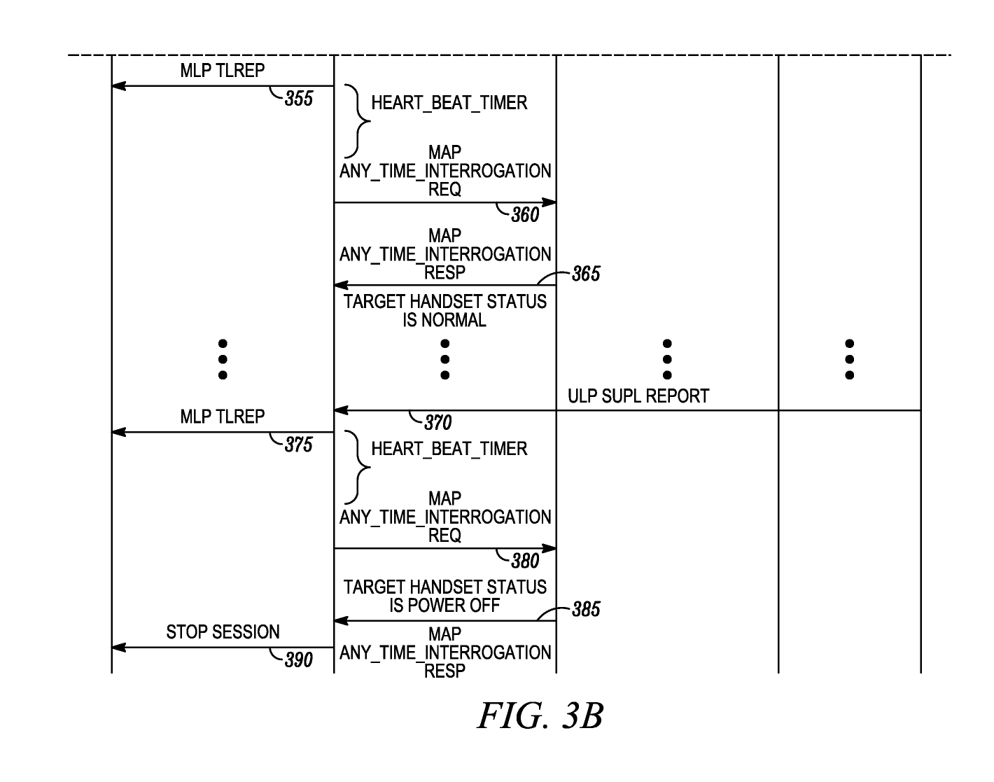

Referring to FIG. 3, a message sequence chart illustrates a method for notifying the LCS client 155, in the wireless communication network 100, that the target SET 105 is unreachable, according to another embodiment of the present invention. Similar to the initial message exchanges illustrated in FIG. 2, regarding FIG. 3 a mobile location platform trigger location reporting request message (MLP TLRR) 305 is first transmitted from the LCS client 155 to the location server 120, and requests information about the location of the target SET 105. The location server 120 then transmits a user plane location protocol (ULP) SUPL initiation message 310 to the target SET 105, which message 310 initiates a network initiated SUPL positioning process. A data connection setup process 315 is then performed at the target SET 105, and the target SET 105 transmits a ULP SUPL triggered start message 320 back to the location server 120 to negotiate parameters of the positioning process with the location server 120. The location server 120 then transmits to the target SET 105 a ULP SUPL triggered response message 325, which is used to negotiate further parameters of the positioning process. The location server 120 also transmits to the LCS client 155 a MLP triggered location reporting answer (TLRA) message 330, which is an MLP protocol message that informs the LCS client 155 of the result of the MLP TLRR message 305.

The target SET 105 then responds to the location server 120 with a ULP SUPL position initiation message 335, which is a further ULP protocol message. A ULP SUPL positioning process 340, which is initiated by the location server 120, is then performed between the location server 120 and the target SET 105. The location server 120 then transmits to the target SET 105 a ULP SUPL report message 345, which requests a location report from the target SET 105. The target SET 105 then responds with another ULP SUPL report message 350, which delivers a GPS position result to the location server 120. The GPS position result is then transmitted from the location server 120 to the LCS client 155 in the form of a MLP trigger location report (TLREP) message 355.

Subsequently, the location server 120 expects to receive periodic additional ULP SUPL report messages from the target SET 105 and to transmit periodic additional MLP TLREP messages to the LCS client 155. However, after expiration of a predetermined period assigned to a heart_beat_timer, which can comprise various types of conventional clocking or timing mechanisms known to those having ordinary skill in the art, the location server 120 transmits a MAP any_time_interrogation request message 360 to the HLR 140. The message 360 requests a status of the target SET 105. The HLR 140 then informs the location server 120 of a current status of the target SET 105. For example, the HLR 140 transmits a MAP any_time_interrogation response message 365 to the location server 120 that indicates that a status of the target SET 105 is normal. The location server 120 then continues to receive periodic messages, such as a ULP SUPL report message 370, from the target SET 105, and transmits regular positioning update messages, such a MLP TLREP message 375, to the LCS client 155.

If the predetermined period of the heart_beat_timer again expires, the location server 120 transmits another MAP any_time_interrogation request message 380 to the HLR 140. The HLR 140 then transmits to the location server 120 another MAP any_time_interrogation response message 385 that indicates that the target SET 105 is powered off or out of service. The location server 120 then transmits a stop session message 390 to the LCS client 155. Similar to the embodiment illustrated in FIG. 2, the LCS client 155 is thus less likely to use inaccurate or outdated positioning data and, by terminating the positioning session with the location server 120, processor and power resources of the LCS client 155, the location server 120, and the wireless communication network 100 can be conserved.

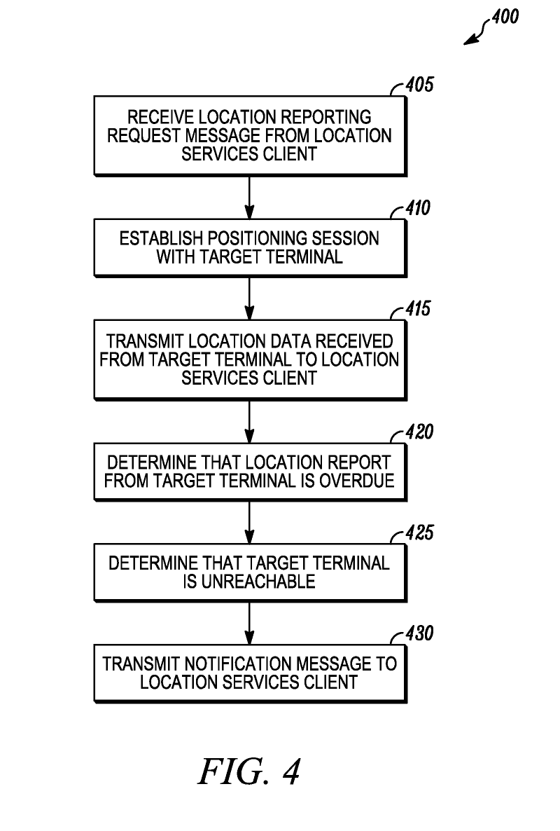

Referring to FIG. 4, a flow diagram illustrates a method 400 for notifying a location services client that a target terminal is unreachable, according to an embodiment of the present invention. At step 405 a location server receives from the location services client a location reporting request message that requests information about the location of the target terminal. For example, as described above, the location server 120 receives a MLP TLRR message, such as the message 205 or the message 305, from the LCS client 155.

At step 410, a positioning session is established between the location server and the target terminal. For example, as described above, a positioning session is established between the location server 120 and the target SET 105 through the ULP SUPL positioning process 240 or the ULP SUPL positioning process 340.

At step 415 the location server transmits to the location services client, after establishing the positioning session between the location server and the target terminal, location data received from the target terminal. For example, the MLP TLREP messages 255, 355 are transmitted from the location server 120 to the LCS client 155.

At step 420, the location server determines that a location report from the target terminal is overdue. For example, determining that a location report from the target terminal is overdue may comprise determining that a missing report counter has exceeded a predetermined threshold. As described above, that may include at block 270 the missing report counter reaching a predetermined value of “N”. Alternatively, determining that a location report from the target terminal is overdue may comprise determining that a timer of location reports received from the target terminal has expired. As described above, that may include determining at the location server 120 that a heart_beat_timer has expired and then transmitting the MAP any_time_interrogation request message 380 from the location server 120 to the HLR 140.

At step 425, the location server determines, in response to determining that the location report is overdue, that the target terminal is unreachable. For example, as described above, the location server 120 determines that the target SET 105 is unreachable by processing the MAP any_time_interrogation response message 280, or the message 385, received from the HLR 140 and indicating that the target SET 105 is powered off.

At step 430, the location server transmits to the location services client a notification message indicating that the target terminal is unreachable. For example, as described above, the stop session message 285 or message 390 is transmitted from the location server 120 to the LCS client 155.

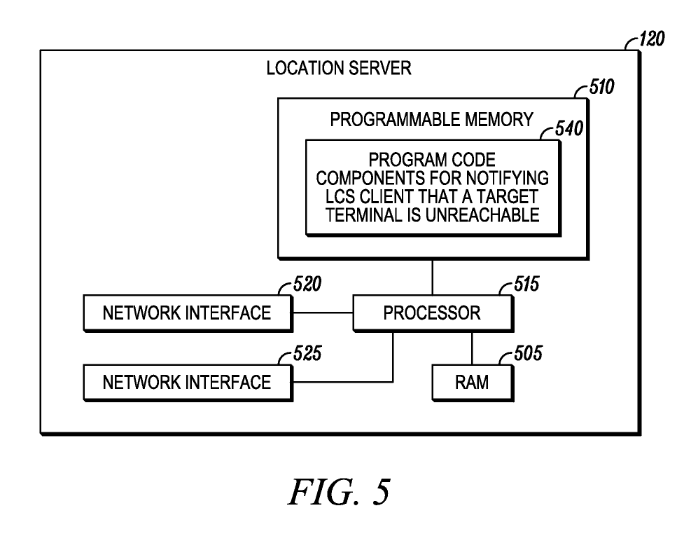

Referring to FIG. 5, a block diagram illustrates components of the location server 120, according to an embodiment of the present invention. The location server 120, for example, can comprise a SUPL location platform (SLP) containing at least all the elements depicted in FIG. 5, as well as any other elements necessary for the location server 120 to perform its particular functions. Alternatively, the location server 120 can comprise a collection of appropriately interconnected units or devices, wherein such units or devices perform functions that are equivalent to the functions performed by the elements depicted in FIG. 5.

The location server 120 comprises a random access memory (RAM) 505 and a programmable memory 510 that are coupled to a processor 515. The processor 515 also has ports for coupling to network interfaces 520, 525. The network interfaces 520, 525 can be used to enable the location server 120 to communicate with other devices in various types of wired or wireless communication networks. For example the network interface 520 may communicate with the MLP interface 150 that enables the location server 120 to transmit MLP messages, such as the MLP TLREP message 375, to the LCS client 155.

The programmable memory 510 can store operating code (OC) for the processor 515 and code for performing functions associated with a location server. For example, the programmable memory 510 can store computer readable program code components 540 configured to cause execution of a method, such as the method 400, for notifying a location services client that a target terminal is unreachable, as described herein.

Methods according to some embodiments of the present invention conform to the Open Mobile Alliance Secure User Plane Location 2.0 standard.

Wireless portable electronic devices, such as the target SET 105, that utilize and benefit from embodiments of the present invention can utilize various types of wireless network architectures including a mesh enabled architecture (MEA) network, or an Institute of Electrical and Electronics Engineers (IEEE) 802.11 network (e.g., 802.11a, 802.11b, 802.11g, 802.11n). It will be appreciated by those of ordinary skill in the art that such wireless communication networks can alternatively comprise any packetized communication network where packets are forwarded across multiple wireless hops. For example, such a wireless communication network can be a network utilizing multiple access schemes such as OFDMA (orthogonal frequency division multiple access), TDMA (time division multiple access), FDMA (Frequency Division Multiple Access), or CSMA (Carrier Sense Multiple Access).

Advantages of some embodiments of the present invention therefore include enabling an LCS client to be promptly notified when a location server is unable to accurately report a position of a target terminal because, for example, the target terminal has become out of service or has been powered off. The LCS client is thus less likely to use inaccurate or outdated positioning data, and processor and power resources of the LCS client, the location server, and the network in which they operate can be conserved.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, or contains a list of elements does not include only those elements but may include other elements not expressly listed or inherent to such process, method, article, or apparatus. An element preceded by “comprises a . . . ”, “has a . . . ”, “includes a . . . ”, or “contains a . . . ” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for notifying a location services client that a target terminal is unreachable, the method comprising:
receiving at a location server from the location services client a location reporting request message that requests information about the location of the target terminal;
establishing a positioning session between the location server and the target terminal;
determining at the location server that a location report from the target terminal is overdue;
determining at the location server, in response to determining that the location report is overdue, that the target terminal is unreachable; and
transmitting from the location server to the location services client a notification message indicating that the target terminal is unreachable.

2. The method of claim 1, wherein determining that a location report from the target terminal is overdue comprises determining that a timer of location reports received from the target terminal has expired.

3. The method of claim 1, wherein determining that a location report from the target terminal is overdue comprises determining that a missing report counter has exceeded a predetermined threshold.

4. The method of claim 1, further comprising:
transmitting from the location server to the location services client, after establishing the positioning session between the location server and the target terminal, location data received from the target terminal.

5. The method of claim 1, wherein determining that the target terminal is unreachable comprises transmitting an interrogation request message to a home location register (HLR) of the target terminal.

6. The method of claim 1, wherein the positioning session between the location server and the target terminal is a secure user plane location (SUPL) positioning session.

7. The method of claim 1, wherein the location reporting request message is a mobile location platform trigger location reporting request (MLP TLRR) message.

8. The method of claim 1, wherein the method conforms to an Open Mobile Alliance Secure User Plane Location standard.

9. A location server comprising:
a processor; and
a memory operatively coupled to the processor, wherein the memory comprises:
computer readable program code components for receiving at the location server from a location services client a location reporting request message that requests information about the location of a target terminal;
computer readable program code components for establishing a positioning session between the location server and the target terminal;
computer readable program code components for determining at the location server that a location report from the target terminal is overdue;
computer readable program code components for determining at the location server, in response to determining that the location report is overdue, that the target terminal is unreachable; and
computer readable program code components for transmitting from the location server to the location services client a notification message indicating that the target terminal is unreachable.

10. The location server of claim 9, wherein determining that a location report from the target terminal is overdue comprises determining that a timer of location reports received from the target terminal has expired.

11. The location server of claim 9, wherein determining that a location report from the target terminal is overdue comprises determining that a missing report counter has exceeded a predetermined threshold.

12. The location server of claim 9, wherein the memory further comprises:
computer readable program code components for transmitting from the location server to the location services client, after establishing the positioning session between the location server and the target terminal, location data received from the target terminal.

13. The location server of claim 9, wherein determining that the target terminal is unreachable comprises transmitting an interrogation request message to a home location register (HLR) of the target terminal.

14. The location server of claim 9, wherein the positioning session between the location server and the target terminal is a secure user plane location (SUPL) positioning session.

15. The location server of claim 9, wherein the location reporting request message is a mobile location platform trigger location reporting request (MLP TLRR) message.

16. A location server for notifying a location services client that a target terminal is unreachable, the apparatus comprising:
means for receiving at the location server from the location services client a location reporting request message that requests information about the location of the target terminal;
means for establishing a positioning session between the location server and the target terminal;
means for determining at the location server that a location report from the target terminal is overdue;
means for determining at the location server, in response to determining that the location report is overdue, that the target terminal is unreachable; and
means for transmitting from the location server to the location services client a notification message indicating that the target terminal is unreachable.

17. The location server of claim 16, wherein determining that a location report from the target terminal is overdue comprises determining that a timer of location reports received from the target terminal has expired.

18. The location server of claim 16, wherein determining that a location report from the target terminal is overdue comprises determining that a missing report counter has exceeded a predetermined threshold.

19. The location server of claim 16, further comprising:
means for transmitting from the location server to the location services client, after establishing the positioning session between the location server and the target terminal, location data received from the target terminal.

20. The location server of claim 16, wherein determining that the target terminal is unreachable comprises transmitting an interrogation request message to a home location register (HLR) of the target terminal.
